(19) United States
(12) Patent Application Publication
(10) Pub. No.: US 2007/0039135 A1
(43) Pub. Date: Feb. 22, 2007

(54) Hinge assembly for foldable electronic device

(75) Inventors: Chao Duan, Shenzhen (CN); Chia-Hua Chen, Tu-cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD, Shindian City (TW)

(21) Appl. No.: 11/450,650

(22) Filed: Jun. 9, 2006

(30) Foreign Application Priority Data
Aug. 19, 2005 (CN) 200510036749.2

(51) Int. Cl. E05D 11/10

(52) U.S. Cl. 16/330

(57) ABSTRACT

An exemplary hinge assembly (100) includes a shaft (10), a cam member (14), a resilient member (40), a cam (20), and a torsional member (30). The cam member is fixed relative to the shaft. The resilient member is mounted on one end of the shaft. The cam has a second cam portion (22). The cam is slidably and rotatably movable relative to the shaft. The second cam portion is engaged with the first cam portion urged by the resilient member. The torsional member is configured for providing a torsional force between the cam and the shaft.

### TECHNICAL FIELD

The present invention generally relates to hinge assemblies and, more particularly, to a hinge assembly for hinging together housings of foldable electronic devices such as mobile telephones, electronic notebooks, and the like.

### BACKGROUND

With the development of wireless communication and information processing technologies, portable electronic devices such as mobile telephones and electronic notebooks are now in widespread use. These electronic devices enable consumers to enjoy the high technology services anytime and anywhere. Foldable electronic devices are particularly favored by consumers for their convenience and ease of storage.

Generally, foldable electronic devices have most of the electronics in one housing, called the body. The other housing, called the cover, normally contains fewer electronic components than the body. Other foldable electronic devices have all the electronics in the body, thus the cover contains no electronics and serves only to cover a keypad and/or a display of the body. Various types of hinge assemblies are used to join the body and the cover of a foldable electronic device, so that the cover can unfold up from and fold down upon the body.

A typical hinge assembly used in small foldable electronic devices includes a shaft, a fixing member, a fixed cam, a rotary sliding cam, and a compression spring. An end portion of the shaft extends through the fixed cam, the rotary sliding cam, the compression spring, and the fixing member in that order, thereby integrating the hinge assembly into a modular unit. While opening or closing the foldable electronic device, a large friction force is produced between the shaft, the fixed cam, and the rotary sliding cam. The friction force can potentially damage the shaft and the fixed cam, thus reducing the working lifetime of the hinge assembly.

What is needed, therefore, is a hinge assembly which overcomes the above-described shortcomings.

### SUMMARY

In a preferred embodiment described herein, a hinge assembly for a foldable electronic device is provided. The hinge assembly includes a shaft, a cam member, a resilient member, a cam, and a torsional member. The cam member is fixed relative to the shaft. The resilient member is mounted on one end of the shaft. The cam has a second cam portion. The cam is slidably and rotatably movable relative to the shaft. The second cam portion is engaged with the first cam portion urged by the resilient member. The torsional member is configured for providing a torsional force between the cam and the shaft.

Other advantages and novel features of various embodiments will become more apparent from the following detailed description thereof when taken in conjunction with the accompanying drawings.

### BRIEF DESCRIPTION OF THE DRAWINGS

Other aspects of the present hinge assembly can be better understood with reference to the following drawings. The components in the drawings are not necessarily drawn to scale, the emphasis instead being placed upon clearly illustrating the principles of the hinge assembly and its potential applications. Moreover, in the drawings, like reference numerals designate corresponding parts throughout the several views.

FIG. 1 is an isometric view of a foldable electronic device with a hinge assembly according to a preferred embodiment of the present invention;

FIG. 2 is an enlarged, exploded, isometric view of the hinge assembly shown in FIG. 1;

FIG. 3 is similar to FIG. 2, but viewed from another aspect;

FIG. 4 is an assembled, isometric view of the hinge assembly shown in FIG. 2; and

FIG. 5 is a cross-sectional view taken along line V-V of FIG. 4.

### DETAILED DESCRIPTION OF THE PREFERRED EMBODIMENTS

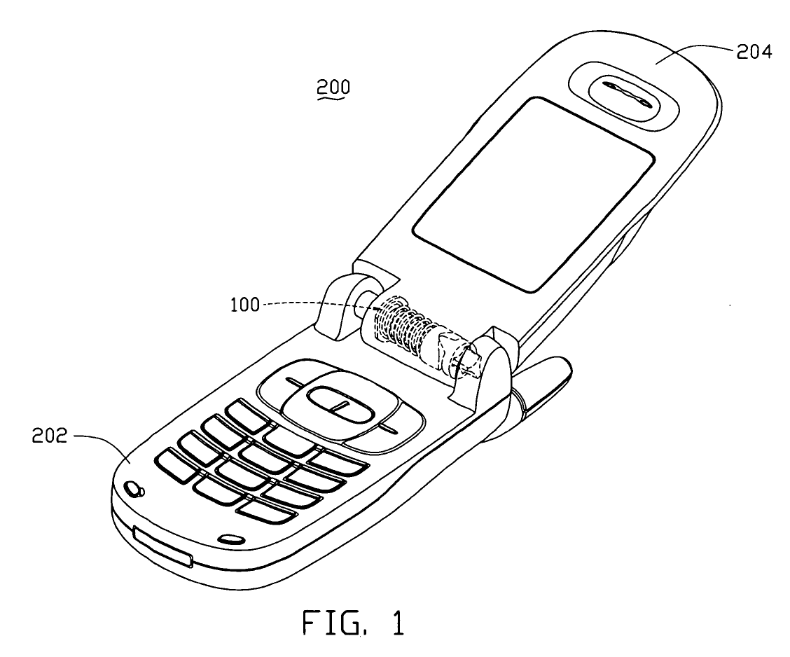

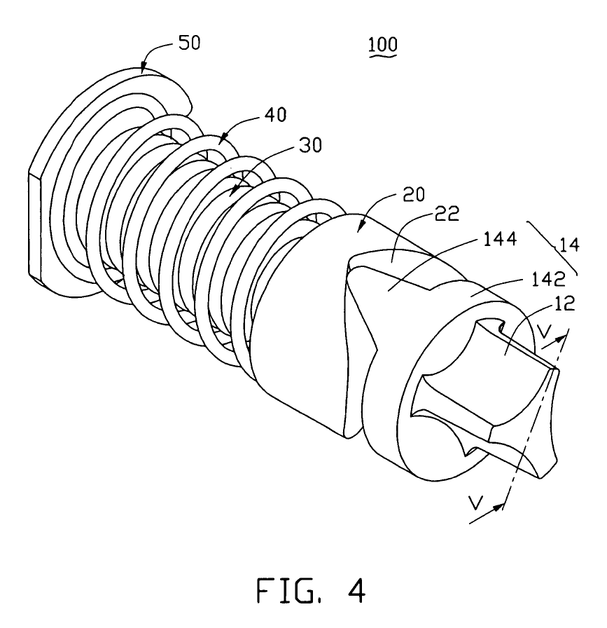

FIGS. 1-4 show a hinge assembly 100 according to a preferred embodiment of the present hinge system. The hinge assembly 100, in the illustrated embodiment, is used to interconnect a body 202 and a cover 204 of a foldable electronic device 200. The hinge assembly 100 includes a shaft 10, a cam 20, a torsional member 30, a resilient member 40, and a disk 50. The shaft 10 extends in turn through the cam 20, the torsional member 30, the resilient member 40, and the disk 50, thereby integrating the hinge assembly 100 into a modular unit. While the hinge assembly 100 is shown incorporated into the foldable electronic device 200, it is to be understood that the hinge assembly 100 or obvious variations thereof may prove useful in other work environments (e.g. cabinet doors) as well.

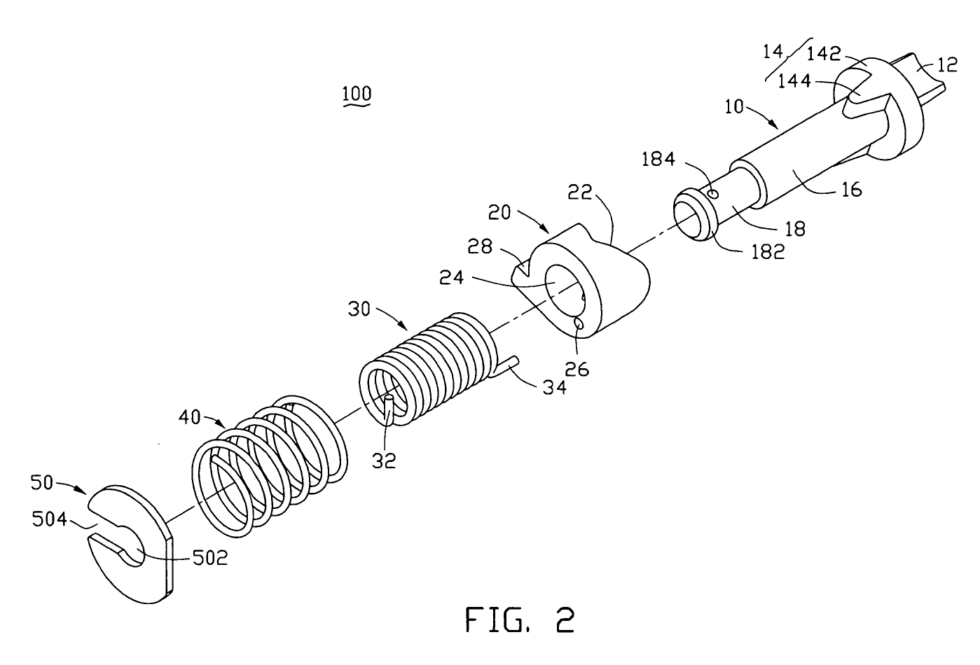

Further referring to FIG. 2, the shaft 10 includes a main shaft portion 16 and a secondary shaft portion 18. The main shaft portion 16 and the secondary shaft portion 18 are coaxially arranged with each other so that the shaft 10 has a first end on the main shaft portion 16 and a second end of the secondary shaft portion 18. The first end is opposite to the second end. A diameter of the main shaft portion 16 is slightly larger than a diameter of the secondary shaft portion 18. A fixing portion 12 is formed at the first end of the shaft 10. The fixing portion 12 is a deformed three-side prism. The fixing portion 12 is configured for fixing with the body 202 of the foldable electronic device 200 so that the shaft 10 is movable with the body 202. A first cam portion 14 is formed on the main shaft portion 16 adjacent to the fixing portion 12. The first cam portion 14 includes a circular flange 142 and a pair of protrusions 144. Each of the protrusion 144 extends from one side of the flange 142 opposite to the fixing portion 12. The protrusions 144 are spaced apart from each other by an angle of about 180 degrees. The secondary shaft portion 18 defines a first mounting hole 184 therein. A positioning portion 182 is formed at the second end of the shaft 10. The positioning portion 182 is a substantially circular flange and has a larger diameter than the diameter of the secondary shaft portion 18.

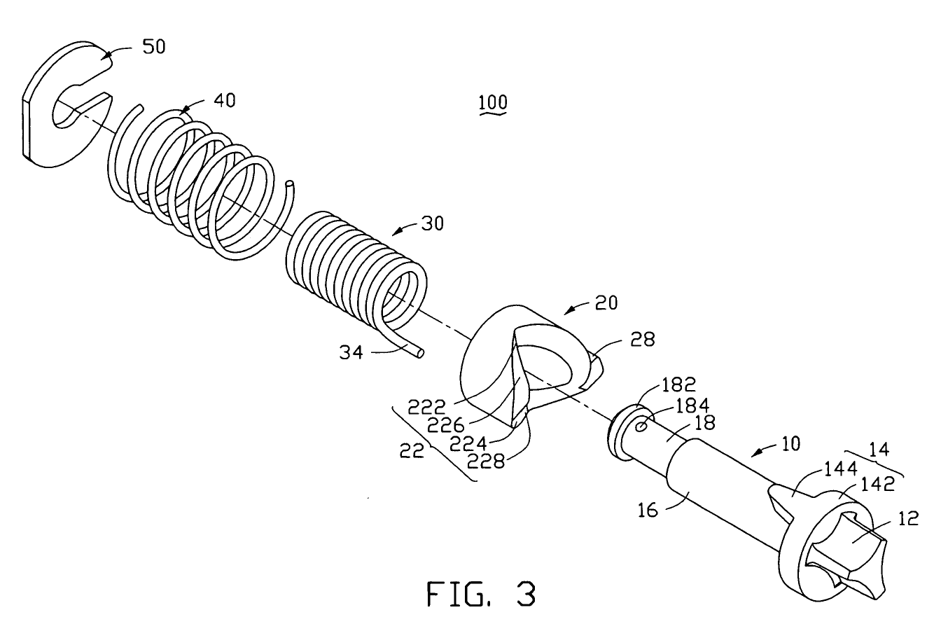

Further referring to FIG. 3, the cam 20 is substantially in the form of a hollow barrel and has a cavity 24. The cam 20 has a second cam portion 22 formed at one end thereof The second cam portion 22 has a pair of valleys 222 and a pair of peaks 224. The valleys 222 are separated from each other by an angle of about 180 degrees. A slow slope 226 and a steep slope 228 are respectively formed at two sides of each peak 224. The slow slope 226 has a smaller obliquity than that of the steep slope 228. The cam 20 defines a second mounting hole 26 in the other end thereof A projection 28 is formed on an outer periphery of the cam 20 extending from one end to the other end. The projection 28 is configured for fixing with the cover 204 so that the cam 20 is movable with the cover 204.

The torsional member 30 is preferably made of metal and is spiral-shaped (i.e. a coiled spring). The torsional member 30 has a first mounting end 32 extending in a radial direction and a second mounting end 34 extending in an axial direction. The first mounting hole 184 of the shaft 10 is configured for receiving the first mounting end 32 therein. The second mounting hole 26 of the cam 20 is configured for receiving the second mounting end 34 therein.

The resilient member 40 is preferably made of metal and is spiral-shaped (i.e. a coil spring). A diameter of the resilient member 40 is slightly larger than a diameter of the torsional member 30 so that the torsional member 30 can be inserted through the resilient member 40.

The disk 50 is made of elastic material, and has a circular hole 502 defined through a central portion thereof and a cutout 504 defined through a peripheral portion thereof. The cutout 504 communicates with the hole 502. A diameter of the hole 502 is substantially equal to the diameter of the secondary shaft portion 18. A width of the cutout 504 is smaller than the diameter of the hole 502.

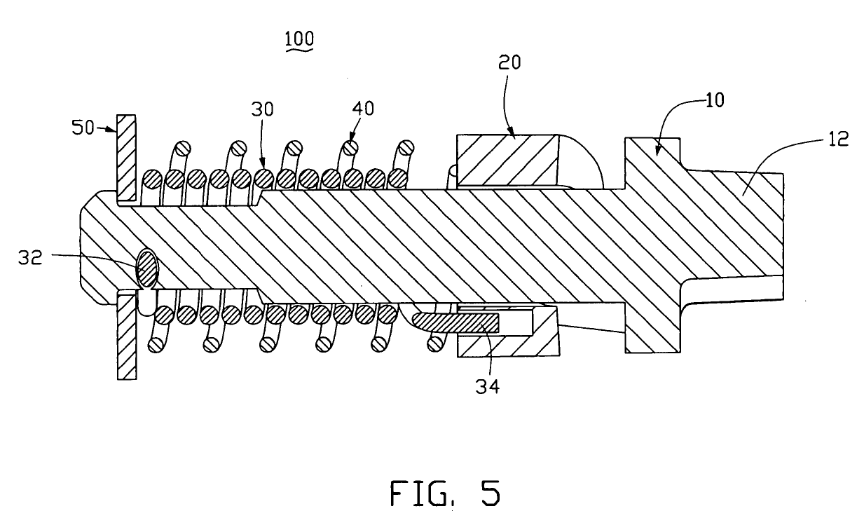

Referring to FIGS. 5 and 6, in assembly of the hinge assembly 100, the second end of the shaft 10 is inserted through the cavity 24 of the cam 20, the torsional member 30, and the resilient member 40. The secondary shaft portion 18 of the shaft 10 is inserted through the cutout 504 and into the hole 502, the disk 50 thereby being secured on the shaft 10. One end of the resilient member 40 abuts against the disk 50 and the other opposite end of the resilient member 40 abuts against the cam 20. The first mounting end 32 of the torsional member 30 is mounted in the first mounting hole 184 of the shaft 10. The second mounting end 34 of the torsional member 30 is mounted in the second mounting hole 26 of the cam 20. The first cam portion 14 of the shaft 10 is engaged with the second cam portion 22 of the cam 20 urged by the resilient member 40. The protrusions 144 of the first cam portion 14 are received in the valleys 222 of the second cam portion 22. The fixing portion 12 is fixed to the body 202 of the foldable electronic device 200. The projection 28 of the cam 20 is fixed to the cover 204 of the foldable electronic device 200. In this position, the resilient member 40 is compressed and the torsional member 30 is twisted. The compression force of the resilient member 40 is larger than the torsional force of the torsional member 30 so that the cover 204 is held in a closed position.

To open the foldable electronic device 200, the cover 204 is manually pushed in a direction from the first end of the shaft 10 toward the second end of the shaft 10. The cam 20 moves together with the cover 204. During this process, the torsional member 30 and the resilient member 40 are compressed, and the valleys 222 are moved away from the protrusions 144. The cam 20 is rotated in an opening direction due to the torsional force of the torsional member 30. The top end of the protrusion 144 slides along the steep slope 228 from the valley 222 to the peak 224. When the top end of the protrusion 144 slides over the peak 224, the cover 204 is released. The cam 20 continues to rotate in the open direction and move to the first end of the shaft 10 due to the cooperation of the decompressed resilient member 40, the torsional member 30, and the slow slope 226. The cover 204 continues to open until the protrusion 144 moves into another valley 222.

To close the foldable electronic device 200, the cover 204 is manually rotated towards the body 202 causing the cam 20 to rotate relative to the shaft 10. By the engagement between the second cam portion 22 of the cam 20 and the first cam portion 14 of the shaft 400, the cam 20 is pushed axially towards the disk 50. During this process, the torsional member 30 and the resilient member 40 are compressed further. When the top end of the protrusion 144 slides over the peak 224, the cover 204 is released. The cam 20 continues to rotate relative to the body and moves towards the first end of the shaft 10 due to the cooperation of the decompressed resilient member 40, the torsional member 30, and the slow slope 226. The cover 204 continues to close until the protrusion 144 moves into another valley 222.

It is to be understood that the torsional member 30 and the resilient member 40 may alternatively be made of another material (e.g. plastic or rubber). The resilient member 40 may alternatively have a different configuration, for example, a leaf spring or a resilient cylinder. The first cam portion 14 may be separately attached to the shaft 10. The first cam portion 14 may be fixed to the shaft 10 or be configured to rotate with the shaft 10. The disk 50 may be omitted. The positioning portion 182 can be configured to position the resilient member 40.

It is believed that the present embodiments and their advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

We claim:

1. A hinge assembly, comprising:
a shaft;
a cam member having a first cam portion, the cam member being rotatable with the shaft;
a resilient member mounted on one end of the shaft;
a cam having a second cam portion, the cam being slidable and rotatable relative to the shaft, and the second cam portion being engaged with the first cam portion by the resilient member; and
a torsional member configured for providing a torsional force between the cam and the shaft.

2. The hinge assembly as claimed in claim 1, further comprising a disk mounted on one end of the shaft for positioning the resilient member.

3. The hinge assembly as claimed in claim 1, wherein the shaft includes a main shaft portion, and a positioning portion is formed at one end thereof for positioning the resilient member.

4. The hinge assembly as claimed in claim 1, wherein the resilient member is either a compression spring or a cylindrical rubber.

5. The hinge assembly as claimed in claim 1, wherein the torsional member is a torsional spring, one end of the torsional spring is fixed to the cam and the other end of the torsional spring is fixed to the shaft.

6. The hinge assembly as claimed in claim 5, wherein the torsional spring has a first mounting end extending in a radial direction and a second mounting end extending in an axial direction, the shaft defines a first mounting hole configured for receiving the first mounting end and the cam defines a second mounting hole configured for receiving the second mounting end.

7. The hinge assembly as claimed in claim 1, wherein the cam member is either integrally formed as part of the shaft or is a piece separately attached to the shaft.

8. A foldable electronic device, comprising:
a first body;
a second body; and
a hinge assembly rotatably connecting the first body and the second body, the hinge assembly comprising:
a shaft;
a cam member having a first cam portion and the cam member being rotatable with the shaft;
a resilient member mounted on one end of the shaft;
a cam having a second cam portion, the cam being slidably and rotatably movable relative to the shaft, and the second cam portion being engaged with the first cam portion by the resilient member; and
a torsional member configured for providing a torsional force between the cam and the shaft.

9. The hinge assembly as claimed in claim 8, further comprising a disk mounted on one end of the shaft for positioning the resilient member.

10. The hinge assembly as claimed in claim 8, wherein the shaft includes a main shaft portion, and a positioning portion is formed at one end thereof for positioning the resilient member.

11. The hinge assembly as claimed in claim 8, wherein the resilient member is either a compression spring or a cylindrical rubber.

12. The hinge assembly as claimed in claim 8, wherein the torsional member is a torsional spring, one end of the torsional spring is fixed to the cam and the other end of the torsional spring is fixed to the shaft.

13. The hinge assembly as claimed in claim 12, wherein the torsional spring has a first mounting end extending in a radial direction and a second mounting end extending in an axial direction, the shaft defines a first mounting hole configured for receiving the first mounting end and the cam defines a second mounting hole configured for receiving the second mounting end.

14. The hinge assembly as claimed in claim 8 wherein a projection is provided on a periphery of the cam, and the projection is configured to allow it to be being fixed to the first body so that the cam is movable relative to the first body.

15. The hinge assembly as claimed in claim 8, wherein the cam member is either integrally formed as part of the shaft or is a component separately attached to the shaft.

16. The hinge assembly as claimed in claim 8, wherein a fixing portion is provided at one end of the shaft, and the fixing portion is configured to allow it to be fixed to the second body so that the shaft is movable along with the second body.

17. A hinge assembly comprising:
a hinge shaft having a longitudinal axis;
a first cam member configured so as to be fixed relative to the hinge shaft;
a second cam member rotatably and longitudinally movably attached to the hinge shaft;
a first resilient member arranged to bias the second cam member against the first cam member along the longitudinal axis; and
a second resilient member arranged to bias the second cam along a rotation direction around the hinge shaft in a manner so as to cause the second cam member to rotate when force of the first resilient member moves the second cam member toward the first cam member.

18. The hinge assembly as claimed in claim 17, wherein the second resilient member has opposite two ends, one end of the resilient member being fixed relative to the second cam member, and the other end of the resilient member being fixed relative to the hinge shaft.

19. The hinge assembly as claimed in claim 18, wherein the second resilient member includes a torsional spring having two spring ends, the second cam member defines a cam mounting hole engagingly receiving one of the spring ends, and the hinge shaft defines a shaft mounting hole engagingly receiving the other of the spring ends.

20. The hinge assembly as claimed in claim 17, wherein the second cam member includes a valley with a slow slope and a deep slope formed at opposite two sides of the valley, the slow slope has a smaller obliquity than that of the deep slope, and the first cam member includes a protrusion slidingly engaging with the slow and deep slopes when the second cam member rotates relative to the first cam member.
